(19) United States
(12) Patent Application Publication
(10) Pub. No.: US 2003/0198850 A1
(43) Pub. Date: Oct. 23, 2003

(54) Structured document mapping apparatus and method

(75) Inventors: Ayane Suzuki, Kawasaki (JP); Katsuhiko Yuura, Kodaira (JP); Taiki Sakata, Kawasaki (JP)

Correspondence Address: Hogan & Hartson, Biltmore Tower, Suite 1900, 500 South Grand Avenue, Los Angeles, CA, 90071, US

(73) Assignee: HITACHI, LTD.

(21) Appl. No.: 10/302,156

(22) Filed: Nov. 21, 2002

(30) Foreign Application Priority Data
Apr. 23, 2002 (JP) 2002-120208

(51) Int. Cl. G06F 7/00

(52) U.S. Cl. 429/30

(57) ABSTRACT

A structured document mapping apparatus that correlates items included in text document data inputted to items of hierarchical document having attributes and a structure. The structured document mapping apparatus refers to at least one of a standard taxonomy and a corporation-unique taxonomy, and automatically maps the items of the input text document according to the rules stored in a search database and creates an XBRL document that corresponds to attributes and structure of the standard taxonomy or the corporation-unique taxonomy.

### BACKGROUND OF THE INVENTION

1. Field of the Invention

The present invention relates to a mapping technology for structured documents, and to a technology that uses structured documents in XBRL (eXtensible Business Reporting Language). More particularly, the present invention also relates to a structured document mapping apparatus and method that uses structured documents in XBRL (eXtensible Business Reporting Language) in the field of accounting.

2. Description of Related Art

In the past, accounting information was expressed using various tools and languages, but a movement is currently underway in the accounting world to standardize the way accounting information is stated by using XBRL, which is based on XML (eXtensible Markup Language).

In one existing technology, all items of accounts of a corporation are first mapped by hand into items in a conforming standard taxonomy, and while each item of accounts is conformed (i.e., without inconsistencies) to the hierarchies of the standard taxonomy, those items of accounts that cannot be mapped are used to create a unique taxonomy for the corporation. If a unique taxonomy already exists, those items of accounts that cannot be mapped into the standard taxonomy are added to the existing unique taxonomy. To create instance documents, items of accounts that are to be in the instance documents are mapped and input by hand in a manner described above into the standard taxonomy and the corporation's unique taxonomy, and the instance documents are subsequently created.

In another existing technology, mapping between documents that use tags to establish clearly defined structures, such as mapping from SGML to HTML, is performed.

The former prior art described above provides a tool to create only taxonomies or a tool to create only instance documents, but it has a problem in that it cannot support mapping.

### SUMMARY OF THE INVENTION

The present invention attempts to solve the above problem and to support the creation of taxonomies and instance documents by mapping corporations' items of accounts into XBRL taxonomies as XBRL becomes more widely used.

In order to solve the above problem, the present invention maps text documents, which do not have structural information but are an aggregate of information with similar properties, and documents (taxonomy), which have hierarchy and attributes, and creates instance documents by establishing structure through such mapping.

For example, items of accounts in the field of accounting are included in text documents and taxonomies. Among text documents is included a balance sheet in which various items of accounts, such as items of accounts under current assets, cash and deposit and short-term investments, have an order relationship to each other. As these show, text documents do not have any hierarchy or attributes as part of their information, but the items have a predetermined relationship to each other in terms of order relationship and positional relationship.

In the present specification, taxonomy documents refer to documents with hierarchy and attributes and include XBRL documents.

Through the structure described above, it becomes possible to reduce the man-hours involved in mapping work, creating and adding taxonomies, and creating instance documents when converting documents containing financial information into XBRL documents or when processing financial information with XBRL.

Other objects, features and advantages of the invention will become apparent from the following detailed description taken in conjunction with the accompanying drawings.

### BRIEF DESCRIPTION OF THE DRAWINGS

FIG. 1 shows a block diagram of a mapping/creating system in accordance with one embodiment of the present invention.

FIG. 2 shows an example of data that is input according to the present invention.

FIG. 3 shows an example of an XBRL document/taxonomy document that is created according to the present invention.

FIG. 4 shows an example of a taxonomy document developed using Excel.

FIG. 5 shows an example of an XBRL document/taxonomy document that is created according to the present invention.

FIG. 6 shows an example of a recommended screen structure of contents arranged in a manner useful to the user.

FIG. 7 shows a flowchart indicating a flow of processing of mapping into taxonomies and creating taxonomy and/or instance documents, as well as a recommended processing flow.

FIG. 8 shows an example in which an item of accounts can be mapped into an existing taxonomy, and in which a taxonomy document and an instance document can be created.

FIG. 9 shows an example in which an item of accounts can be mapped into an existing taxonomy in accordance with a mapping rule, and in which a taxonomy document and an instance document can be created.

FIG. 10 shows an example in which an item of accounts is not found in an existing taxonomy but is added to the existing taxonomy, and in which a taxonomy document and an instance document can be created.

FIG. 11 shows an example in which an item of accounts is not found in an existing taxonomy and is not added to the existing taxonomy.

FIG. 12 shows an example in which an item of accounts is not found in an existing taxonomy but is added to an existing taxonomy, and in which correlation information is not input.

FIG. 13 shows an example in which an item of accounts is found in an existing taxonomy, and in which only a taxonomy document can be output.

FIG. 14 shows a continuation of the processing flow from FIG. 7.

FIG. 15 shows a continuation of the processing flow from FIG. 10.

### DESCRIPTION OF PREFERRED EMBODIMENTS

An embodiment of the present invention will be described below with reference to the accompanying drawings.

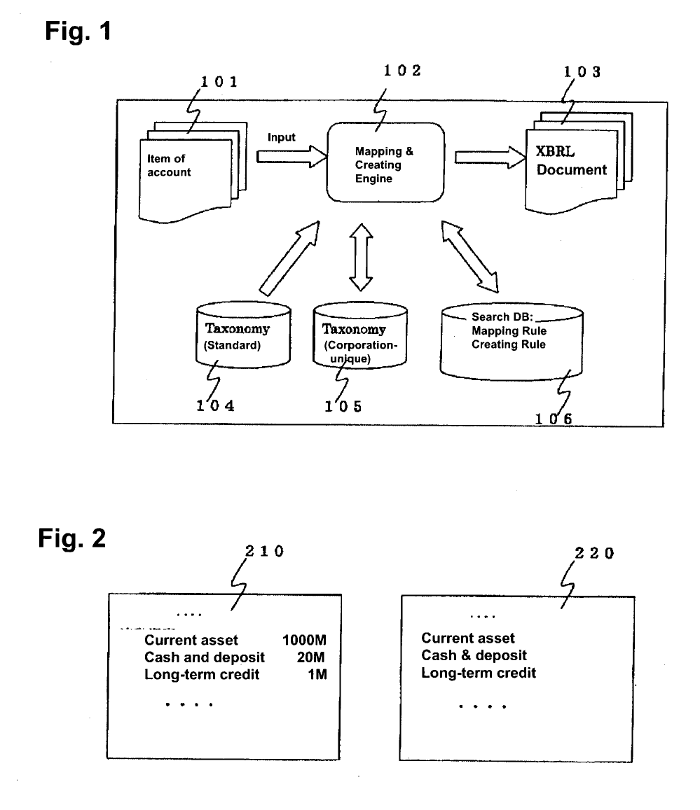

FIG. 1 is a block diagram indicating the structure of a mapping and creating system 100 in accordance with an embodiment of the present embodiment. The operations of this system will be described later. Only the components are described for now. The present system can be realized using a normal computer having at least a processor, a bus, a memory and a storage. In addition, this system, like normal computers, can be connected to networks including the Internet.

Items of accounts 101 are financial information that is input via an input device. The financial information is a text document and includes, for example, information 210 and 220 shown in FIG. 2. The items of accounts 101 include items of accounts with values (210) and items of accounts without values (220). Each of the items of accounts 101 has an order relationship that indicates its order position in relation to current assets, cash and deposit or long-term credits.

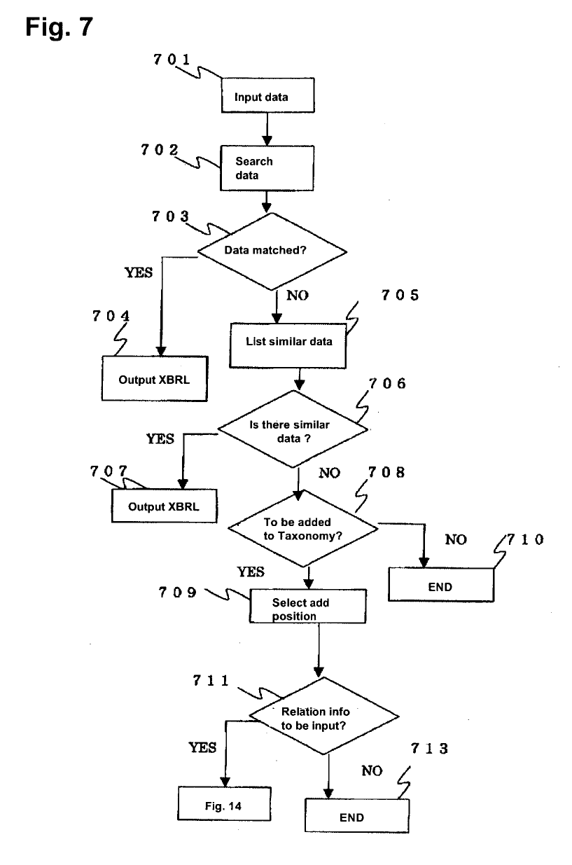

A mapping and creating engine 102 is a program that executes processing according to the present embodiment. The details of the processing will be described using FIG. 7, but the processing is briefly described below.

For each item of accounts 101 (financial information) that was input and that can be stored in a storage, the mapping and creating engine 102 refers to at least one of a standard taxonomy 104, which is a dictionary having at least one of attributes or structure, and a corporation-unique taxonomy 105, which is a taxonomy unique to the corporation that handles the items of accounts 101, and executes processing according to the rules of a search database (DB) 106. In other words, the mapping and creating engine 102 uses the order position of the item of accounts 101 that was input to create an XBRL document 103 that corresponds to the attributes and structure of the standard taxonomy 104 or the corporation-unique taxonomy 105.

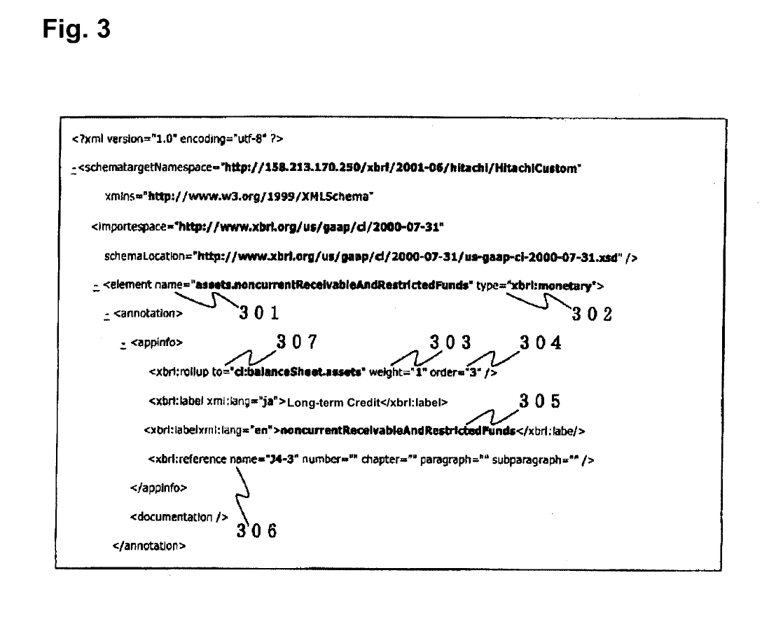

FIG. 3 is an example of a taxonomy expressed in XBRL. An element name 301 has a plurality of attributes: a data type 302, a weight 303, an order 304, a label 305, and a reference 306. Hierarchical relations are built by a roll-up 307.

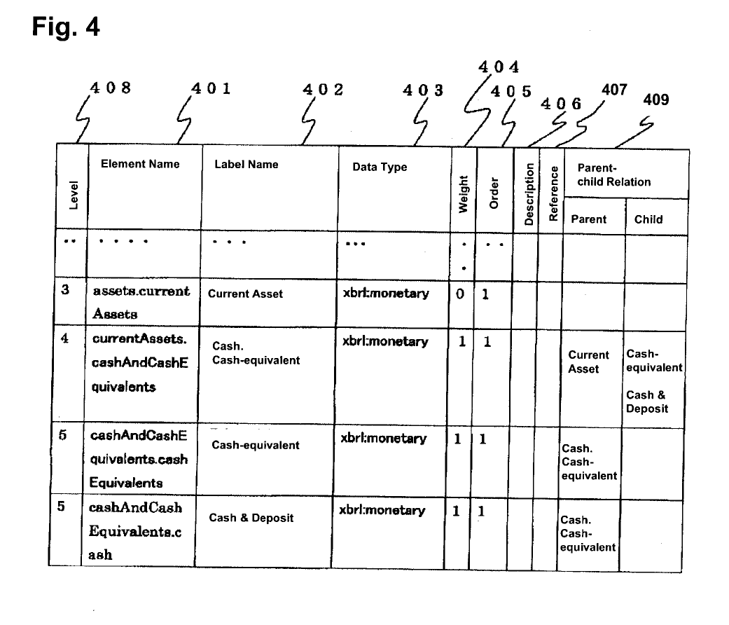

FIG. 4 is a specific example of taxonomy expressed in a spreadsheet. Each element name 401 has a plurality of attributes: a data type 403, a weight 404, an order 405, a label 402, a description 406, and a reference 407. The hierarchical relations are expressed by a level 408. In this example, items at the same level in the hierarchy are assigned the same value. For example, both “cash equivalents” and “cash & deposit” are assigned level 5, which indicates that they are at the same level in the hierarchy. Further, the lower the level value of the item, the higher the level of the item in the hierarchy (parent). A parent-child relation 409 specifies the item of accounts that has a parent relationship or a child relationship with the element name in question.

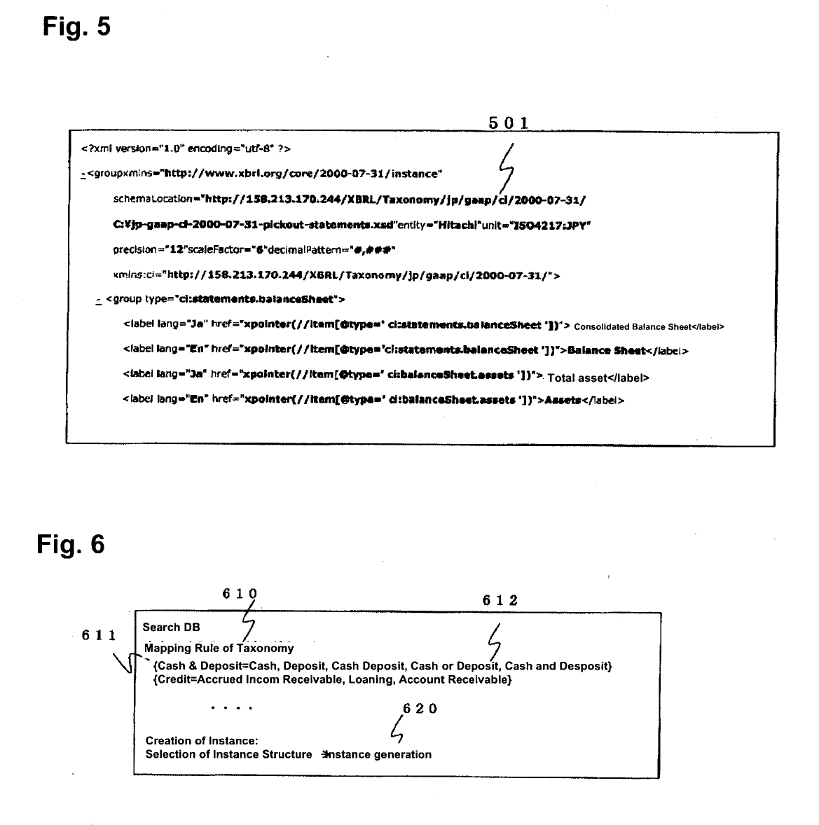

FIG. 5 is an example of an instance document in accordance with an embodiment of the present invention that the mapping and creating engine 102 creates by referring to the taxonomies 104 and 105 and following the rules of the search DB 106. A description 501 states that the instance document has reference to a taxonomy. FIG. 6 is an example of a search database. A description 610, which is one of the taxonomy mapping rules, is a fuzzy search rule. To the left of the “=” mark is an expression “cash & deposit” 611, which is registered in the taxonomy, and to the right of the “=” mark is an expression 612, which is not registered in the taxonomy but has the same meaning in accounting terms. An instance creating rule 620 states to select the structure of an instance and to create the instance according to the instance structure selected.

Next, referring to FIG. 7 the flow of processing in accordance with the present embodiment will be described. FIG. 7 expresses the flow of processing executed by the mapping and creating engine 102.

First, in step 701, the mapping and creating engine 102 accepts an input of the items of accounts 101, which is a text document. The input is executed using an input device shown in FIG. 1 or via a network.

Next, in step 702, the mapping and creating engine 102 searches in the taxonomies 104 and 105 for an item that corresponds to each of the items of accounts 101 that were input. First, for the first item to be searched among the items of accounts 101 that were input, the mapping and creating engine 102 searches for an item that corresponds to it in the label name 402 from the taxonomy shown in FIG. 4, for example. The first search item may be arbitrary, or it can be an item that is first in the order relationship, or it can be an item that is last in the order relationship. In this case, the first search item is “current assets” in the information 210 (or 220). As a result of the search, “current assets” in level 3 in FIG. 4 is found.

Next, the mapping and creating engine 102 searches for “cash and deposit” in the information 210 (or 220). Since the last search result yielded “current assets,” the mapping and creating engine 102 may search for “cash and deposit” among items that are at level 3, which is the same label as the “current assets,” and that share the same parent “assets” in FIG. 4. In other words, the mapping and creating engine 102 uses the level 408 and the parent-child relationship 409 in FIG. 4 to search. In the search described above as an example of the embodiment of the present invention, the mapping and creating engine 102 first searches for “cash and deposit” in level 3, and if there are any matches it searches for items among the matches that shares the same parent “assets.” However, this order maybe reversed.

In the taxonomy shown in FIG. 4 that is used in this example, however, there is no item called “cash and deposit” among items that are at level 3 and whose parent is “assets.” Consequently, the mapping and creating engine 102 searches for “cash and deposit” in lower items (descendants) under “current assets.” First, the mapping and creating engine 102 searches for “cash and deposit” in level 4, which is the next level down from level 3. In the taxonomy shown in FIG. 4, there is only “cash equivalents” and no “cash and deposit.” Consequently, the mapping and creating engine 102 searches in level 5, which is the next level down from level 4. In the taxonomy shown in FIG. 4, there are “cash equivalents” and “cash & deposit” in level 5. Here, the mapping and creating engine 102 outputs as the search result “cash & deposit,” whose content is the same as that of the “cash and deposit” that was input. In this manner, the search result does not have to be exactly the same in its expression as the search item, as long as it indicates similar content as the search item. Existing technologies such as the “synonyms development technique” and “different notation development method” can be used to specify items with similar contents. Next, the mapping and creating engine 102 executes a similar search for “long-term debt” based on the last search result “cash & deposit.”

The mapping and creating engine 102 executes searches in the following manner: First, among items that are at the same level as the last search result and that share the same parent as the last search result of the items recorded in the taxonomy, the mapping and creating engine 102 searches for the new search item that was input. Next, if there are no matches resulting from this search, the mapping and creating engine 102 executes a search among lower items under the last search result of the items recorded in the taxonomy. However, this search order maybe reversed. That is, a search among lower items can be done first, and if there are no matches, a search among items in the same level and that share the same parent as the last search result can be done.

In order to realize searches as described above, a column to indicate previous search results can be provided and the previous search results flagged individually in the taxonomy, so that previous search results can be recorded to distinguish them from other items in the taxonomy.

Alternatively, a search result table can be provided. Information (for example, search time, search order) that indicates a temporal relationship between contents that are recorded in the taxonomy and that correspond to search items, and the time each item was searched, can be recorded in the search result table. By doing this, it will be possible to record a history of search results in the search result table. Additionally, information concerning the item that was searched most recently can be written over information recorded earlier in the search result table. Furthermore, the level 408 and the parent-child relationship 409 for each search result can be recorded in the search result table.

In the present embodiment, items that are specified by the search result table or by flags in the taxonomy become the items among which searches are to be conducted.

In these searches, the searches can be conducted among the following groups of items in the following order: descendants (items at a lower level) of siblings, parent and parent's siblings, descendants of parent's siblings, parent's parent and its siblings, descendants of parent's parent's siblings. In this example, siblings refer to items that are at the same level and that share the same parent. In these searches, if a match is found in one of the searches among various groups of items, searches in subsequent groups of items can be omitted. Additionally, if a plurality of matches is found as search results in a plurality of searches among different groups of items, the match that was found first can be considered the search result. Furthermore, if there is a plurality of matches, the candidate matches can be provided as an output so that the user can make the determination as to which is the correct search result, rather than having the system automatically refine the search results.

The items among which searches are done may be altered based on the history of search results recorded in the search result table in performing searches. For example, if the number of siblings found is the same as the number of levels indicated by the taxonomy in a search for an item, the search among siblings can be omitted and only searches among items at lower levels may be performed.

Next, in step 703, the mapping and creating engine 102 determines whether any search result was yielded from step 702 (i.e., whether the data that was input matches the data that was found). If it was found (YES), the mapping and creating engine 102 outputs in step 704 an XBRL document matching the search result.

If it was not found, the mapping and creating engine 102 searches in step 705 for similar data in accordance with a mapping rule. The mapping rule may be that the matching rate between the item name that was input and the text of the label name 402 in the taxonomy must be above a predetermined value. Or, the item that was input may be subject to a synonyms development and/or a different notation development using a dictionary program, and each of these developed items may be done in a manner described in step 702. In other words, using the level of the last search result as reference, data that are candidates are listed from the taxonomy. Fuzzy search algorithm may be used for the similar data search.

Next, the mapping and creating engine 102 determines in step 706 whether there are any similar data. If there are, an XBRL document that is associated with the taxonomy is output in step 707. This processing is similar to the processing in step 704.

Next, in step 708, the mapping and creating engine 102 determines whether to add to a corporation-unique taxonomy those items of accounts 101 that cannot be mapped. Instead of having the system execute this processing, this determination can be made by a person and this processing executed based on the input of the person's decision.

Next, if it was determined in step 708 that the items of accounts 101 can be added to the corporate-unique taxonomy, the mapping and creating engine 102 executes such addition in step 709. For example, candidates for add positions in the taxonomy are displayed using the level of the last item (the last search result) as the reference. Based on this display, the user can select an add position, and the mapping and creating engine 102 adds the candidate to the position corresponding to the position selected. The add position with the level of the last item as the reference includes at least one of the level or the parent-child relationship that is the same as that of the last item. Consequently, specifying the add position involves specifying at least one of the level or the parent-child relationship to be the same as that of the last item.

Next, if it is determined in step 708 that the items of accounts 101 cannot be added to the corporation-unique taxonomy, the mapping and creating engine 102 does not make any additions to the taxonomy and terminates the processing in step 710.

In step 711, the mapping and creating engine 102 determines whether to input correlation information for the items of accounts 101 added. If the answer is NO, the processing is terminated in step 713.

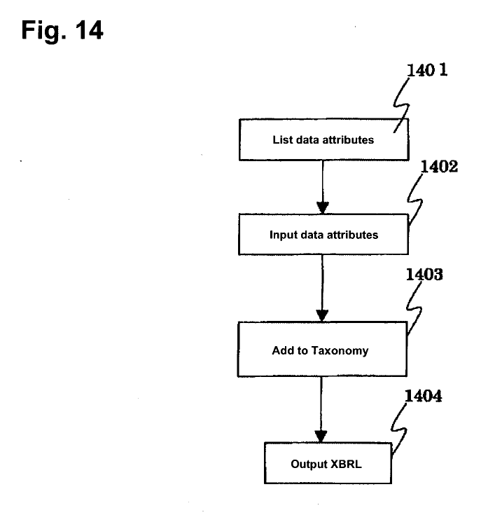

If the answer in step 711 is YES, the processing in FIG. 14 follows, which is described below. In step 1401, attributes of the items of accounts 101 that are added if the answer is YES are listed. The result of the last processing step is used for this.

Next, the mapping and creating engine 102 accepts an input of attribute values of data in step 1402. In step 1403, the attribute values that were input are added to the corporation-unique taxonomy. In step 1404, the mapping and creating engine 102 outputs a taxonomy or an instance document, depending on the result added.

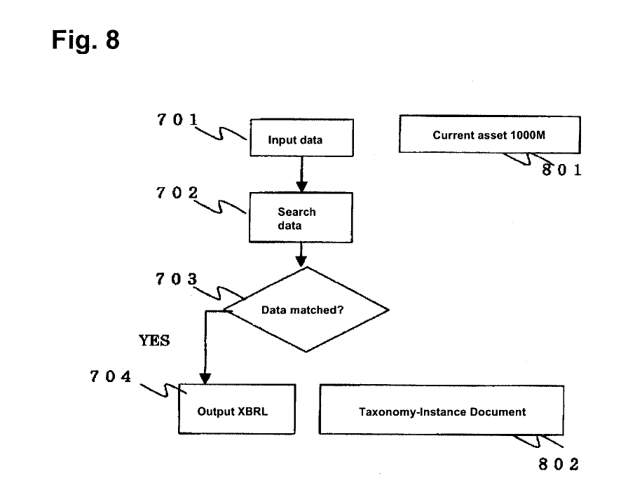

FIG. 8 is a flowchart indicating one example to which the processing flow in FIG. 7 has been applied using a specific item of accounts and using the taxonomy in FIG. 4 as the reference. An item of accounts 801: “current assets 100M” is input in step 701. In the processing flow, taxonomy data is searched in step 702, a determination that the data matches is made in step 703, and an XBRL document is output in step 704. 802 represents “a taxonomy document and an instance document,” the documents that can be provided as outputs.

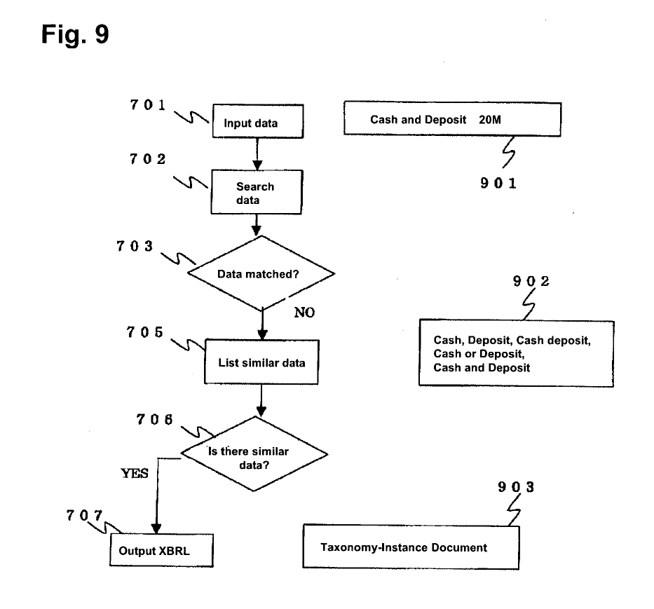

FIG. 9 is a flowchart indicating one example to which the processing flow in FIG. 7 has been applied using a specific item of accounts and using the taxonomy in FIG. 4 as the reference. An item of accounts 901: “cash and deposit 20M” is input in step 701. The subsequent flow of processing is as described below. It is the same as the flow described earlier. Taxonomy data is searched in step 702. If it is determined in step 703 that there are no data matches, similar data are searched according to the taxonomy mapping rule 610 in FIG. 6 and listed in step 705. If it is determined in step 706 that there is a similar data, an XBRL document is output in step 707.

A reference number 902 represents specific examples of similar data listed in step 705. A reference number 903 represents “a taxonomy document and an instance document,” the documents that can be provided as outputs.

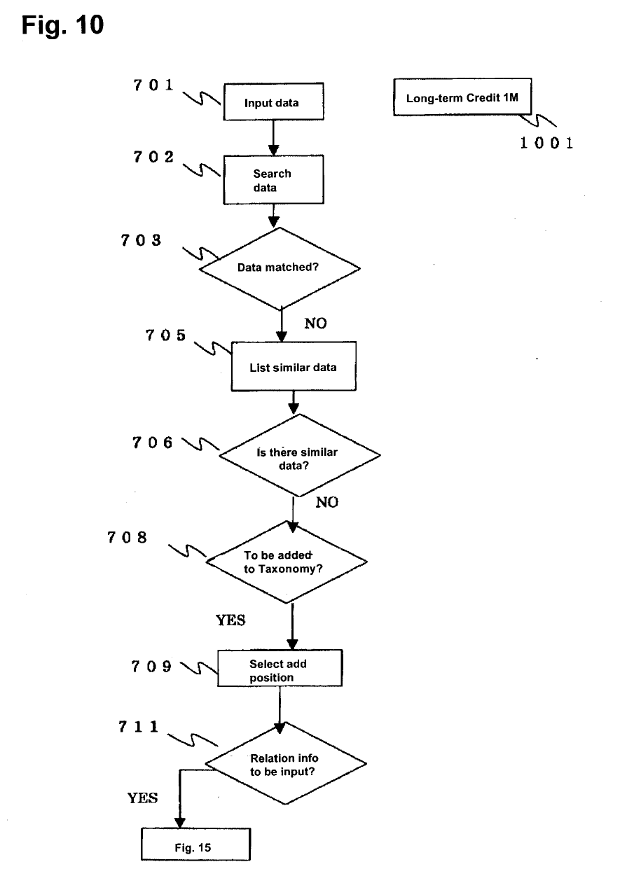

FIG. 10 is a flowchart indicating one example to which the processing flow in FIG. 7 has been applied using a specific item of accounts and using the taxonomy in FIG. 4 as the reference. An item of accounts 1001: “long-term credit 1M” is input in step 701. The subsequent flow of processing is as described below, which is the same as the flow described earlier.

Taxonomy data is searched in step 702. If it is determined in step 703 that there are no data matches, similar data are searched according to the taxonomy mapping rule 610 in FIG. 6 and listed in step 705. In this case, it is determined in step 706 that there are no similar data.

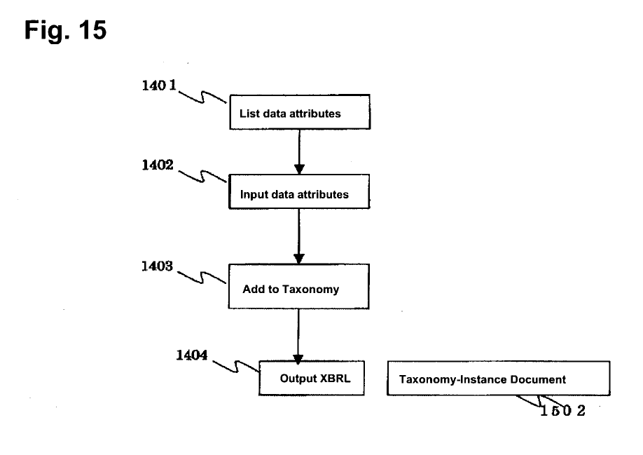

If it is determined in step 708 to add the item of accounts 1001 to a corporation-unique taxonomy, the add position in the taxonomy is selected in step 709. If it is determined in step 711 to input correlation information, steps described in FIG. 15 follow. First, attributes of the items of accounts 1001 that are to be added are listed in step 1401. In step 1402, the input of attribute values is accepted. In step 1403, the attribute values are added to the corporation-unique taxonomy, and an XBRL document is provided as an output in step 1404. Reference number 1502 represents “a taxonomy document and/or an instance document,” the document that can be provided as an output.

FIG. 15 shows the continuation of the processing flow from FIG. 10. Reference number 1502 represents “a taxonomy document and an instance document,” the document that can be provided as outputs.

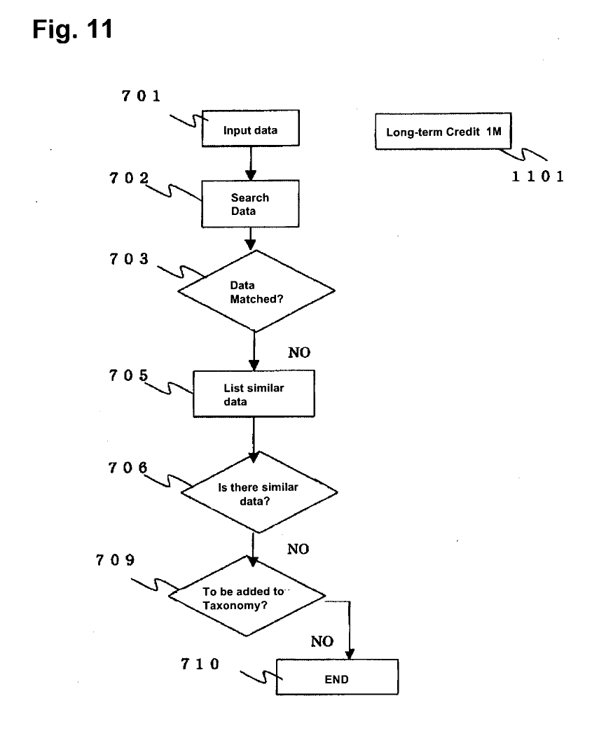

FIG. 11 is a flowchart indicating one example to which the processing flow in FIG. 7 has been applied using a specific item of accounts and using the taxonomy in FIG. 4 as the reference. An item of accounts 1101: “long-term credit 1M” is input in step 701. The subsequent flow of processing is as described below, which is the same as the flow described earlier. First, taxonomy data is searched in step 702. If it is determined in step 703 that there are no data matches, similar data are searched according to the taxonomy mapping rule 610 in FIG. 6 and listed in step 705. If it is determined in step 706 that there are no matching data, and if it is determined in step 709 not to add the item of accounts 1101 to a corporation-unique taxonomy, the processing is terminated in step 710.

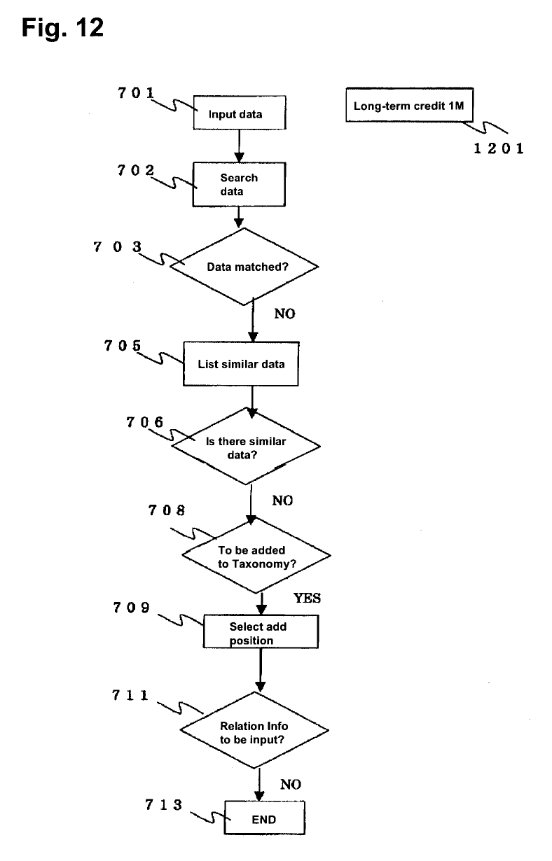

FIG. 12 is a flowchart indicating one example to which the processing flow in FIG. 7 has been applied using a specific item of accounts and using the taxonomy in FIG. 4 as the reference. An item of accounts 1201: “long-term credit 1M” is input in step 701. The subsequent flow of processing is as described below, which is the same as the flow described earlier. Taxonomy data is searched in step 702. If it is determined in step 703 that there are no data matches, similar data are searched according to the taxonomy mapping rule 610 in FIG. 6 and listed in step 705. If it is determined in step 706 that there are no similar data, it is determined in step 708 to add the item of accounts 1201 to the taxonomy.

In step 709, the add position to the taxonomy is selected (or a selection made by a person is accepted). If it is determined in step 711 not to input correlation information, the processing is terminated in step 713.

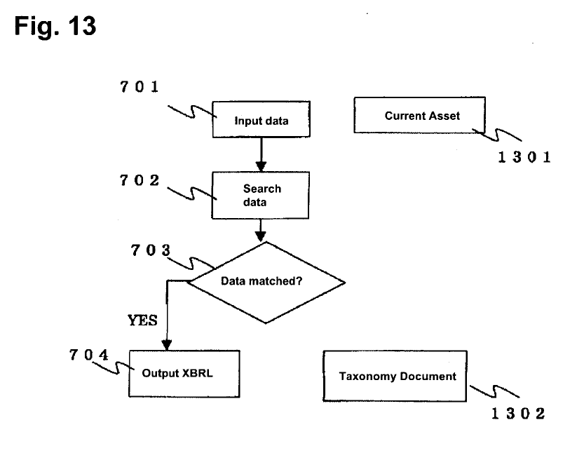

FIG. 13 is a flowchart indicating one example to which the processing flow in FIG. 7 has been applied using a specific item of accounts and using the taxonomy in FIG. 4 as the reference. An item of accounts 1301: “current assets” is input in step 701. The subsequent flow of processing is as described below, which is the same as the flow described earlier. Taxonomy data is searched in step 702. If it is determined in step 703 that there are no data matches, an XBRL document is provided as an output in step 704. 1302 represents “a taxonomy document,” which is the only document that can be provided as an output, since the item of accounts 1301 does not have any value attached to it.

In preparing financial reports, the time and work involved in mapping items of accounts into taxonomies, creating taxonomies, and creating instance documents can be reduced drastically, and the efficiency of such work can be improved.

According to the present invention, document data such as text document that does not contain information representing either attributes or structure can be mapped into hierarchical document data that has attributes or structure, and hierarchical document data that has attributes or structure can be created.

While the description above refers to particular embodiments of the present invention, it will be understood that many modifications may be made without departing from the spirit thereof. The accompanying claims are intended to cover such modifications as would fall within the true scope and spirit of the present invention.

The presently disclosed embodiments are therefore to be considered in all respects as illustrative and not restrictive, the scope of the invention being indicated by the appended claims, rather than the foregoing description, and all changes which come within the meaning and range of equivalency of the claims are therefore intended to be embraced therein.

What is claimed is:

1. A structured document mapping apparatus that correlates items included in text document data to items of hierarchical document having attributes and/or a structure, the structured document mapping apparatus comprising:
a program that is readable by the structured document mapping apparatus;
a storage medium that stores level data for the items of the hierarchical document, each level data indicating a level of each of the items among the hierarchical document and parent-child relation data that indicates a hierarchical relation of one of the items with other of the items among the hierarchical document;
an input device that accepts input of the items of the text document in an order according to a predetermined relation among the items;
a processor that is connected to the storage medium and that searches according to the program for the items of the hierarchical document that correspond to the respective items of the text document inputted by the input device in accordance with a process comprising the steps:
detecting a first level data among the level data and a first parent-child relation data among the parent-child relation data for a first item among the items of the hierarchical document that corresponds to a first item among the items of the text document that has been input immediately before a second item among the items of the text document; and
searching as a search object for an item, having level data and parent-child relation data having a predetermined relation with the detected first level data and the first parent-child relation data, among the items of the hierarchical document that corresponds to the second item of the text document.

2. A structured document mapping apparatus according to claim 1, wherein the processor conducts a search for the search object that has level data and parent-child relation data that are identical with the first level data and the first parent-child relation data, respectively.

3. A structured document mapping apparatus according to claim 1, wherein the processor conducts a search for the search object as a lower item with respect to the first item among the items of the hierarchical document, that has a level lower than the level defined by the first level data and that is specified based on the first parent-child relation data.

4. A structured document mapping apparatus according to claim 1, wherein the storage medium stores attributes or a structure of the items as the hierarchical document, and the processor creates a hierarchical document from the text document using the attributes or the structure of the items detected.

5. A structured document mapping apparatus according to claim 1, wherein the processor searches for any one of the items among the hierarchical document in correlating a first one of the items among the text document that is input first to the items among the hierarchical document.

6. A structured document mapping method that correlates items included in text document data to items of hierarchical document having attributes and/or a structure, the structured document mapping method comprising the steps of:
storing level data for the items of the hierarchical document, each level data indicating a level of each of the items among the hierarchical document and parent-child relation data that indicates a hierarchical relation of one of the items with other of the items among the hierarchical document;
accepting input of the items of the text document in an order according to a predetermined relation among the items;
detecting a first level data among the level data and a first parent-child relation data among the parent-child relation data for a first item among the items of the hierarchical document that corresponds to a first item among the items of the text document that has been input immediately before a second item among the items of the text document; and
searching as a search object for an item, having level data and parent-child relation data having a predetermined relation with the detected first level data and the first parent-child relation data, among the items of the hierarchical document that corresponds to the second item of the text document.

7. A structured document mapping method according to claim 6, wherein the step of searching includes executing a search for the search object that has level data and parent-child relation data that are identical with the first level data and the first parent-child relation data, respectively.

8. A structured document mapping method according to claim 7, wherein the step of searching includes executing a search for the search object as a lower item with respect to the first item among the items of the hierarchical document, that has a level lower than the level defined by the first level data and that is specified based on the first parent-child relation data.

9. A structured document mapping method according to claim 6, wherein the step of storing includes storing attributes or a structure, of the items as the hierarchical document, and the processor creates a hierarchical document from the text document using the attributes or the structure of the items detected.

10. A structured document mapping method according to claim 6, wherein the step of searching includes conducting a search for any one of the items among the hierarchical document in correlating a first one of the items among the text document that is input first to the items among the hierarchical document.

11. A structured document mapping apparatus that correlates items included in text document data to items of hierarchical document, the structured document mapping apparatus comprising:
a storage device that stores level data for the items of the hierarchical document, each level data indicating a level of each of the items among the items of the hierarchical document and parent-child relation data that indicates a hierarchical relation of one of the items with other of the items of the hierarchical document;
an input device that accepts input of the items of the text document in an order according to a predetermined relation among the items; and
a device that detects a first level data among the level data and a first parent-child relation data among the parent-child relation data for a first item among the items of the hierarchical document that corresponds to a first item among the items of the text document that has been input immediately before a second item among the items of the text document;
a search device that searches as a search object for an item, having level data and parent-child relation data having a predetermined relation with the detected first level data and the first parent-child relation data, among the items of the hierarchical document that corresponds to the second item of the text document.

12. A structured document mapping apparatus according to claim 11, wherein the search device conducts a search for the search object that has level data and parent-child relation data that are identical with the first level data and the first parent-child relation data, respectively.

13. A structured document mapping apparatus according to claim 11, wherein the search device conducts a search for the search object as a lower item with respect to the first item among the items of the hierarchical document, that has a level lower than the level defined by the first level data and that is specified based on the first parent-child relation data.

14. A structured document mapping apparatus according to claim 11, wherein the storage medium stores attributes or a structure of the items of the hierarchical document, and the processor creates a hierarchical document from the text document using the attributes or the structure of the items detected.

15. A structured document mapping apparatus according to claim 11, wherein the search device selects any one of the items among the hierarchical document in correlating a first one of the items among the text document that is input first to the items among the hierarchical document.

16. A structured document mapping method that correlates items included in text document data to items of hierarchical document, the structured document mapping method comprising the steps of:
storing level data for the items of the hierarchical document, each level data indicating a level of each of the items among the items of the hierarchical document and parent-child relation data that indicates a hierarchical relation of one of the items with other of the items of the hierarchical document;
detecting a first level data among the level data and a first parent-child relation data among the parent-child relation data for a first item among the items of the hierarchical document that corresponds to a first item among the items of the text document that has been input immediately before a second item among the items of the text document; and
searching for an item among the items of the hierarchical document that corresponds to the second item of the text document.

17. A structured document mapping method according to claim 16, wherein the step of searching includes a step of searching as a search object for an item, having level data and parent-child relation data having a predetermined relation with the detected first level data and the first parent-child relation data, among the items of the hierarchical document that corresponds to the second item of the text document.

18. A structured document mapping method according to claim 17, wherein the step of searching includes executing a search for the search object that has level data and parent-child relation data that are identical with the first level data and the first parent-child relation data, respectively.

19. A structured document mapping method according to claim 17, wherein the step of searching includes executing a search for the search object as a lower item with respect to the first item among the items of the hierarchical document, that has a level lower than the level defined by the first level data and that is specified based on the first parent-child relation data.

20. A structured document mapping method according to claim 17, wherein the step of storing includes storing attributes or a structure of the items as the hierarchical document, and the processor creates a hierarchical document from the text document using the attributes or the structure of the items detected.

21. A structured document mapping method according to claim 17, wherein the step of searching includes conducting a search for any one of the items among the hierarchical document in correlating a first one of the items among the text document that is input first to the items among the hierarchical document.
